(19) United States
(12) Patent Application Publication
(10) Pub. No.: US 2022/0267636 A1
(43) Pub. Date: Aug. 25, 2022

(54) ONE-PACK POLYURETHANE DISPERSIONS, THEIR MANUFACTURE AND USE

(71) Applicant: BASF Coatings GmbH, Münster (DE)

(72) Inventors: Tobias Schoepping, Münster (DE); Sylvia Zihang, Münster (DE); Beate Podlaski-Pyzik, Münster (DE); Kerstin Sperber, Münster (DE)

(21) Appl. No.: 17/626,391

(22) PCT Filed: Jul. 15, 2020
(86) PCT No.: PCT/EP2020/070037

§ 371 Date: Jan. 11, 2022

(30) Foreign Application Priority Data
Jul. 16, 2019 (EP) 19186451.1

(51) Int. Cl. C09D 175/06; C08G 18/80; C08G 18/79; C08G 18/75; C08G 18/73; C08G 18/68; C08G 18/66; C08G 18/42; C08G 18/34; C08G 18/28; C08G 18/10; C08G 18/08

(52) U.S. Cl. CPC C09D 175/06; C08G 18/8077; C08G 18/792; C08G 18/758; C08G 18/755; C08G 18/73; C08G 18/683; C08G 18/6659; C08G 18/4288; C08G 18/4263; C08G 18/4216; C08G 18/348; C08G 18/286; C08G 18/10; C08G 18/0823

(57) ABSTRACT

Described herein is a method of manufacturing a one-pack polyurethane dispersion, where the dispersion includes a polyurethane containing hydroxyl groups and at least one group selected from the group consisting of acid groups and polyalkoxylene groups, the acid groups of the polyurethane, if present, being neutralized to an extent from 0 to 100 mol-% of the acid groups; and a fully blocked polyisocyanate; where the method includes obtaining a mixture A; reacting a hydroxy-functional polymer with mixture A, thus-obtaining a mixture B; and neutralizing 0 to 100 mol-% of the acid groups, if contained in mixture B, based on the total amount of acid groups in mixture B. Also described herein are one-pack polyurethane dispersions obtainable according to the method, one-pack coating materials including the same and coated substrates including cured coating materials.

The present invention relates to one-pack polyurethane dispersions, a method of their manufacture, their use in coating materials, coating materials containing the same as well as coated substrates obtained by using the coating materials.

### BACKGROUND

The present invention particularly relates to the manufacture of so-called one-pack polyurethane dispersions, i.e. dispersion which are storage stable at ambient temperature, but apt to crosslink at elevated temperatures.

Many one-pack polyurethane dispersions are used in water-borne applications. To accomplish this task, they contain partially or fully neutralized acid groups and/or polyoxyalkylene groups.

Typically, such one-pack polyurethane dispersions are obtained by first forming an isocyanate group containing prepolymer which is afterwards reacted with a polymeric polyol to obtain a polyurethane, see for example DE 4326670 A1, DE 19534361 A1, EP 0791614 A1, DE 4328092 A1 and EP 2341110 B1. The prepolymer, the polymeric polyol or both often contain acid groups such as carboxyl groups and/or polyoxyalkylene groups and after formation of the polyurethane the acid groups, if present, are partially or fully neutralized, preferably with one or more amines or alkali metal hydroxides, to thus obtain water dispersible polyurethane polyols. Those are generally mixed with one or more blocked polyisocyanates to obtain one-pack polyurethane dispersions. However, at high solids contents a rather high viscosity is observed for such dispersions, leading to a limited processability or a need for further dilution.

Therefore, there was a continuing need to provide one-pack polyurethane dispersions having an improved processability and low viscosity. Viscosity and processability are big issues with respect to the pumpability of binder dispersions in big production lines. Typically, viscosities exceeding 3.000 mPas may cause problems and therefore dispersions exceeding a pumpable viscosity need to be diluted first. Another aspect is that such one-pack polyurethane dispersion exhibiting a lower viscosity at a given solids content can be advantageously employed in coating compositions, particularly coating compositions having a high solids content, for example due to a high pigment and/or filler load. Further a manufacturing process should be provided with a reduced effort in storage of components as well as increased simplicity of the process itself and simplified cleaning efforts.

US 2007/004856 A1 relates to self-crosslinking polyurethane dispersion and a process for their preparation. The aim of D1 was to provide improved 1K baking systems, in which the coating compositions have a high solids content and the resultant coatings exhibit good solvent resistance. In the process disclosed in this document, a blocked polyisocyanate is added which can be done at different stages either before, during or after reacting an OH or NCO functional prepolymer with a hydroxyl component and optionally a polyisocyanate component.

### SUMMARY

The aims of the invention were achieved by providing a method for manufacturing a one-pack polyurethane dispersion, were the dispersion comprises
(I) a polyurethane containing hydroxyl groups and at least one group selected from the group consisting of acid groups and polyalkoxylene groups; the acid groups of the polyurethane, if present, being neutralized to an extent from 0 to 100 mol-%, based on the total amount of acid groups; and
(II) a fully blocked polyisocyanate;
characterized in that the method comprises the following steps of
a. manufacturing a prepolymer comprising on average from 1.8 to 2.8 isocyanate groups and comprising urethane groups and at least one group selected from the group consisting of acid groups and polyalkoxylene groups, in the presence of a fully blocked polyisocyanate, thus obtaining mixture A;
b. manufacturing a polyurethane containing hydroxyl groups and at least one group selected from the group consisting of acid groups and polyalkoxylene groups by reacting one or more hydroxy-functional polymers with mixture A, thus obtaining mixture B; and
c. neutralizing from 0 to 100 mol-% of the acid groups, if contained in mixture B, based on the total amount of acid groups in mixture B.

In the following this method is referred to as “method according to the invention”, “method of the invention” or “inventive method”.

Since the one-pack polyurethane dispersions obtained by the method of the present invention significantly differ in viscosity at a given solids content from dispersion making use of the same ingredients in the same amounts, but applying another sequence of the method steps, it is to be concluded, that the one-pack polyurethane dispersions of the invention differ from those conventionally obtained.

The thus obtained one-component polyurethane dispersions are hereinafter referred to as “(one-pack) polyurethane dispersions according to the invention”, “(one-pack) polyurethane dispersions of the invention” or “inventive (one-pack) polyurethane dispersions”. They are a further object of the present invention.

Yet, further objects of the present invention are the use of the one-pack polyurethane dispersions according to the invention in the manufacture of a coating material and the thus obtained coating material itself as well as its method of application.

Another object of the present invention is a coated substrate coated with the one-pack polyurethane dispersions according to the invention, preferably in cured form.

### DETAILED DESCRIPTION

The term “one-pack polyurethane dispersion”, as used herein, means, in analogy with the definition of a “one-pack coating”, a group of polyurethane dispersions which, contrary to “two-pack dispersions”, are dispersions containing crosslinking agent and polyurethane, where these components do not pre-maturely react with each other (see Römpp Lexikon Lacke und Druckfarben, Georg Thieme Verlag, 1998, page 179, keyword “Einkomponenten-Lacke” (one-pack coatings)). The difference between the general term “one-pack polyurethane dispersion” and the narrower term “one-pack coating” is that the “one-pack polyurethane dispersions” according to the present invention do not necessarily contain all typical coating ingredients such as coating additives, pigments and fillers or the like. Typically, the “one-pack polyurethane dispersions” of the present invention become part of “one-pack coatings” by mixing the one-pack polyurethane dispersion with further typical coatings ingredients.

Generally, “one-pack polyurethane dispersions” like “one-pack coatings” do not crosslink at ambient temperature, particularly they do not crosslink at temperatures below 100° C. and preferably below 90° C. and can thus be considered storage stable at typical storage conditions (10 to 40° C.). However, at elevated temperatures preferably above 100° C., more preferred above 120° C. and most preferred above 140° C., crosslinking between the ingredient of the dispersion occurs.

A “polyisocyanate”, according to the invention, is an oligomer containing more than two NCO groups per species. Such polyisocyanates are obtainable by different reactions from diisocyanates, preferably by oligomerization reactions to result in isocyanurates and/or iminooxadiazine diones or oligomers which may contain one or more groups from the group consisting of uretdione groups, biuret groups, allophanate groups, urethane groups and urea groups, preferably in combination with isocyanurate groups and/or iminooxadiazine dione groups.

A “blocked polyisocyanate” is a polyisocyanate, wherein one or more of the NCO groups of the polyisocyanate is reacted with a blocking agent and a “fully blocked polyisocyanate” is a polyisocyanate wherein substantially all NCO groups are reacted with a blocking agent. At elevated temperature, typically higher than 100° C. the blocking agents are split off or in case of malonic acid esters as blocking agents a transesterification occurs when reacted with hydroxyl groups.

The one-pack polyurethane dispersion according to the present invention and manufactured according to the present invention comprises (I) at least one polyurethane containing hydroxyl groups and at least one group selected from the group consisting of acid groups and polyalkoxylene groups, the acid groups of the polyurethane, if present, being neutralized to an extent of 0 to 100 mol-%, based on the total amount of acid groups; and (II) a fully blocked polyisocyanate.

This indicates that manufacturing the fully blocked polyisocyanate which is present while manufacturing the prepolymer which comprises on average from 1.8 to 2.8 isocyanate groups and at least one group selected from the group consisting of acid groups and polyalkoxylene groups, is not or at least not completely consumed during the manufacture of the prepolymer and thus completely or at least partially remains in the one-pack polyurethane dispersion of the present invention.

Method According to the Invention

Method Step a. (Obtaining of Mixture A)

In step a. a prepolymer comprising on average from 1.8 to 2.8 isocyanate groups and comprising urethane groups and at least one group selected from the group consisting of acid groups and polyalkoxylene groups, is manufactured in the presence of a fully blocked polyisocyanate, thus obtaining mixture A.

The prepolymer manufactured in step a. contains 1.8 to 2.8, preferably 1.9 to 2.5 and even more preferred 2.0 to 2.4 NCO groups on average.

Preferably the prepolymer comprises 2 or more urethane groups, more preferred 2 to 4 urethane groups and most preferred 2 urethane groups.

The prepolymer is preferably synthesized reacting diisocyanates with diols. Preferably the acid groups and/or polyalkoxylene groups are introduced into the prepolymer by using diols containing these groups (herein referred to as hydrophilicity introducing diols or hydrophilic diols).

Preferably, method step a. is carried out until at least 30 mol-%, more preferred until at least 50 mol-% and most preferred until at least 70 mol-% of the theoretically possible consumption of the isocyanate groups of the diisocyanates is reached and before 100 mol-% of the theoretically possible consumption of the isocyanate groups of the diisocyanates is reached. Then it is proceeded with method step b. The theoretically possible consumption of the isocyanate groups is a calculated value assuming that all hydroxyl groups present in the diols have been reacted with the isocyanate groups of the diisocyanates.

Diisocyanates

The diisocyanates employed in the manufacture of the prepolymer preferably have the following formula (1)

OCN—R¹—NCO (1)

wherein R¹ is an aliphatic or aromatic hydrocarbon residue, preferably an aliphatic residue. In case of an aliphatic residue, R¹ can be acyclic or cyclic or it can contain acyclic and cyclic moieties. Mixtures of diisocyanates of formula (1) can be employed.

If R¹ is an acyclic aliphatic hydrocarbon residue, R¹ is branched or linear, preferably linear. Preferably the acyclic aliphatic hydrocarbon residue R¹ contains 2 to 16, more preferred 4 to 12 and most preferred 6 to 10 carbon atoms and is preferably linear. A particularly preferred acyclic aliphatic hydrocarbon residue R¹ is (CH₂)ₙ, wherein n=4 to 12, most preferred 6 to 10 such as (CH₂)₆. Examples of the acyclic aliphatic diisocyanates (1) as used in the present invention include hexamethylene diisocyanate and 2,2,4-trimethylhexamethylene diisocyanate.

If R¹ is a cyclic aliphatic hydrocarbon residue or contains acyclic and cyclic moieties, residue R¹ preferably contains 3 to 20, more preferred 6 to 16 and most preferred 10 to 14 carbon atoms. Preferred examples are isophorone diisocyanate, hydrogenated xylylene diisocyanate, 4,4′-diisocyanato dicyclohexylmethane and cyclohexane diisocyanate.

If R¹ is an aromatic hydrocarbon residue, residue R¹ contains preferably 6 to 16, more preferred 6 to 10 carbon atoms. Examples are toluene-2,4-diisocyanate and toluene-2,6-diisocyanate and their mixtures and phenylmethane diisocyanate.

Xylylene diisocyanate and tetramethylxylylene diisocyanate can also be employed and are considered herein as aliphatic diisocyanates because the NCO groups are bound to aliphatic carbon atoms.

Of the above diisocyanates of formula (I), aliphatic diisocyanates or alicyclic diisocyanates are preferred. Particularly preferred are hexamethylene diisocyanate, isophorone diisocyanate, 4,4-diisocyanato dicyclohexylmethane and hydrogenated xylylene diisocyanate.

Hydrophilicity Introducing Diols

The mandatory diols employed in the manufacture of the prepolymer preferably have the following formula (2)

HO—R²—OH (2)

wherein R² is an aliphatic or aromatic hydrocarbon residue, preferably an aliphatic hydrocarbon residue. In case of an aliphatic hydrocarbon residue, R² can be acyclic or cyclic or it can contain acyclic and cyclic moieties. Mixtures of diols of formula (2) can be employed.

R² comprises at least one group selected from the group consisting of acid groups and polyalkoxylene groups. These groups will introduce hydrophilicity into the diol and finally into the prepolymer and polyurethane target polymer. Typically, the acid groups are at least partially neutralized in the polyurethane target polymer, e.g. with amines or alkali metal hydroxides, thus providing an anionic stabilization to the polyurethane in the one-pack polyurethane dispersion.

If R² comprises at least one acid group, the at least one acid group is preferably selected from the group consisting of COOH, SO₃H, OP(O)(OH)₂, P(O)(OH)₂ or its corresponding salts. Most preferred acid groups are COOH groups (carboxylic acid groups). Preferably R² contains one acid groups, most preferred one COOH group.

Examples of the hydrophilicity introducing diols of formula (2) as used in the present invention having one or two acid groups, preferably carboxyl groups within each diol of formula (2) include esters obtained by the reaction between polyhydric alcohols and polybasic acids and/or their anhydrides; and dihydroxyalkanoic acids such as 2,2-dimethylollactic acid, 2,2-dimethylolpropionic acid, 2,2-dimethylolbutanoic acid and 2,2-dimethylolvaleric acid. Examples of preferred compounds include 2,2-dimethylolpropionic acid and 2,2-dimethylolbutanoic acid.

If R² comprises or consists of the at least one polyoxyalkylene group, the at least one polyoxyalkylene group preferably contains ethylene oxide units, more preferred at least 25 mol-% ethylene oxide units, most preferred at least 50 mol-% ethylene oxide units and even more preferred at least 75 mol-% ethylene oxide units such as at least 80 mol-% or at least 90 mol-% and particularly preferred 100 mol-% ethylene oxide units based on the total number of alkylene oxide units. Such other alkylene oxide units are, if contained, preferably selected from the group of propylene oxide units and butylene oxide units.

Preferred examples of the hydrophilicity introducing diols of formula (2) as used in the present invention can be depicted by one or more of formulae (2a) and (2b)

HO—[(EtO)ₓ(PrO)_{y}(BuO)_{z}]—H (2a)

(HOCH₂)₂CX¹CH₂O—[(EtO)ₓ(PrO)_{y}(BuO)_{z}]—X² (2b)

wherein Et=ethylene, Pr=propylene and Bu=butylene, x, y, and z are integers, x+y+z=2 to 200, preferably 3 to 100 and most preferred 4 to 50, x≥2 and x≥(y+z), preferably x≥2(x+y), more preferred x≥3(x+y) and preferably z=0; X¹ and X² are independently of each other linear alkyl groups or cycloalkyl groups, the linear alkyl groups having preferably 1 to 12, more preferred 1 to 8 and most preferred 1 to 6 such as 1 to 5 carbon atoms and the cycloalkyl groups preferable having 3 to 12, more preferred 3 to 8 and most preferred 3 to 6 carbon atoms. X¹ and X² can be identical or different and are preferably different.

In formulae (2a) and (2b) the x EtO groups, y PrO groups and z BuO groups can be organized in blocks, as a gradient or randomly. Most preferred they are organized in blocks or randomly.

It is of course possible to use mixtures of different diols of formula (2) in the manufacture of the prepolymer. Such mixtures can contain different diols with acid groups, different diols with polyalkoxylene groups or mixtures of diols with acids groups and diols with polyoxyalkylene groups.

Further Diols

Beside the hydrophilicity introducing diols of formula (2) further diols can be employed in the manufacture of the prepolymer. Such further diols can be depicted by formula (3)

HO—R³—OH (3)

wherein R³ is an aliphatic or aromatic hydrocarbon residue, preferably an aliphatic hydrocarbon residue, R³ differs from R² and wherein R³ does not contain one or more groups selected from the group consisting of acid groups and polyalkoxylene groups.

In case of an aliphatic residue, R³ can be acyclic or cyclic or it can contain acyclic or cyclic moieties. Mixtures of diols of formula (3) can be employed.

Most preferred R³ is a branched or unbranched, saturated or unsaturated, acyclic aliphatic hydrocarbon residue containing 2 to 12 carbon atoms, more preferred 3 to 11 carbon atoms and most preferred 4 or 5 to 9 carbon atoms. The hydrocarbon residue can be interrupted by 1 to 4 residues or atoms selected from the groups consisting of —O—, —S—, C═O and COO.

Preferred examples of diols of formula (3) are glycols, such as ethylene glycol, propylene glycol, butylene glycol and neopentyl glycol; dialkylene glycols such as diethylene glycol or dipropylene glycol.

If diols of formula (3) are employed in the reaction with the diisocyanates of formula (1) and the diols of formula (2), the preferred molar ratio of diols of formula (2) to diols of formula (3) is from 0.40:0.60 to 0.99:0.01, more preferred from 0.50:0.50 to 0.95:0.05, and even more preferred from 0.60:0.40 to 0.90:0.10.

Prepolymer

The prepolymer formed in method step a. is preferably linear and preferably formed by reacting one or more of the diisocyanates of formula (1) with one or more of the diols of formulae (2) and (3).

The prepolymer contains 1.8 to 2.8, preferably 1.9 to 2.5 and even more preferred 2.0 to 2.4 NCO groups on average.

Preferably the molar ratio of diisocyanates of formula (1) employed in the reaction to the sum of diols of formulae (2) and (3) employed in the reaction is in the range from (2±0.3):1, more preferred (2±0.2):1 and most preferred (2±0.1):1 such as 2:1.

Preferred prepolymers present in mixture A can be depicted by formula (4)

OCN—R¹—NH—C(O)O—R²—O(O)C—NH—R¹—NCO (4)

residues R¹ and R² being as defined above, and if the diol of formula (3) is present, mixture A will further contain prepolymers of formula (4a)

OCN—R¹—NH—C(O)O—R³—O(O)C—NH—R¹—NCO (4a)

residues R¹ and R³ being as defined above.

Without wanting to be bound by theory, some of the NCO groups of the prepolymer can be reacted with NH groups of the NH—(C═O) moieties of the fully blocked polyisocyanates, thus forming allophanate groups or ureide groups. The fully blocked polyisocyanates are not being deblocked by this reaction. Still, a thus modified prepolymer is considered a prepolymer formed in the reaction of method step a. and needs to contain 1.8 to 2.8, preferably 1.9 to 2.5 and even more preferred 2.0 to 2.4 NCO groups on average.

The preparation of the prepolymer in method step a. is preferably carried out at a temperature in the range from 60 to 100° C., more preferred 70 to 90° C. and most preferred 75 to 85° C., such as at 80° C.; preferably in an aprotic organic solvent such as a pyrrolidone like N-methyl-2-pyrrolidone or N-ethyl-2-pyrrolidone or the like and as a ketone like methyl ethyl ketone or methyl isobutyl ketone or the like.

Fully Blocked Polyisocyanates

Generally, the fully blocked polyisocyanates employed in method step a. of the method according to the present invention do not participate in the reaction forming the prepolymer. Particularly, no noticeable deblocking reaction of the fully blocked polyisocyanate employed in method step a. of the method according to the present invention is observed. However, it cannot be excluded, that minor amounts of the NH groups of the NH—(C═O) moieties of the fully blocked polyisocyanates are reacted with free NCO groups of the diisocyanate of formula (1) employed in the formation of the prepolymer forming allophanate groups or ureide groups.

The fully blocked polyisocyanates can be obtained by reacting a polyisocyanate of formula (5)

R⁴—(NCO)ₘ (5)

wherein R⁴ is an aliphatic or aromatic residue derived from the oligomerization of an aliphatic or aromatic diisocyanate of formula (1), preferably an aliphatic diisocyanate of formula (1) and m>2, preferably m=2.5 to 4.5, more preferred m=2.8 to 3.8 with one or more blocking agents.

Preferably R⁴ is obtained by the reaction of three or more diisocyanates of formula (1) and comprises one or more groups selected from isocyanurate groups, iminooxadiazine dione groups, uretdione groups, biuret groups, allophanate groups, urethane groups and urea groups. It is preferred that the polyisocyanate of formula (5) at least comprises isocyanurate groups and/or iminooxadiazine dione groups, both groups being formed by trimerization of diisocyanates of formula (1).

In the synthesis of the fully blocked polyisocyanate, the polyisocyanate of formula (5) contains more than two isocyanate groups (NCO groups; m>2) which are reacted with a blocking agent to become “blocked isocyanate” groups.

Blocking agents for preparing the fully blocked polyisocyanates are for example
i. phenols, pyridinols, thiophenols and mercaptopyridines, preferably selected from the group consisting of phenol, cresol, xylenol, nitrophenol, chlorophenol, ethylphenol, t-butylphenol, hydroxybenzoic acid, esters of this acid, 2,5-di-tert-butyl-4-hydroxytoluene, thiophenol, methylthiophenol and ethylthiophenol;
ii. alcohols and mercaptanes, the alcohols preferably being selected from the group consisting of methanol, ethanol, n-propanol, isopropanol, n-butanol, isobutanol, t-butanol, n-amyl alcohol, t-amyl alcohol, lauryl alcohol, ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether, diethylene glycol monobutyl ether, propylene glycol monomethyl ether, methoxy methanol, 2-(hydroxyethoxy)phenol, 2-(hydroxypropoxy)phenol, glycolic acid, glycolic esters, lactic acid, lactic esters, methylol urea, methylol melamine, diacetone alcohol, ethylene chlorohydrin, ethylene bromohydrin, 1,3-dichloro-2-propanol, 1,4-cyclohexyldimethanol or acetocyano hydrin, and the mercaptanes preferably being selected from the group consisting of butyl mercaptane, hexyl mercaptane, t-butyl mercaptan, t-dodecyl mercaptane;
iii. oximes, preferably the ketoximes of the groups consisting of the ketoxime of tetramethylcyclobutanedione, methyl n-amyl ketoxime, methyl isoamyl ketoxime, methyl 3-ethylheptyl ketoxime, methyl 2,4-dimethylpentyl ketoxime, methyl ethyl ketoxime, cyclohexanone oxime, methyl isopropyl ketoxime, methyl isobutyl ketoxime, diisobutyl ketoxime, methyl t-butyl ketoxime, diisopropyl ketoxime and the ketoxime of 2,2,6,6-tetramethylcyclohexanone; or the aldoximes, preferably from the group consisting of formaldoxime, acetaldoxime;
iv. amides, cyclic amides and imides, preferably selected from the group consisting of lactams, such as ε-caprolactam, δ-valerolactam, γ-butyrolactam or β-propiolactam; acid amides such as acetoanilide, acetoanisidinamide, acrylamide, methacrylamide, acetamide, stearamide or benzamide; and imides such as succinimide, phthalimide or maleimide;
v. imidazoles and amidines;
vi. pyrazoles and 1,2,4-triazoles, such as 3,5-dimethylpyrazole and 1,2,4-triazole;
vii. amines and imines such as diphenylamine, phenylnaphthylamine, xylidine, N-phenylxylidine, carbazole, aniline, naphthylamine, butylamine, dibutylamine, butylphenylamine and ethyleneimine;
viii. imidazoles such as imidazole or 2-ethylimidazole;
ix. ureas such as urea, thiourea, ethyleneurea, ethylenethiourea or 1,3-diphenylurea;
x. active methylene compounds such as dialkyl malonates like diethyl malonate, and acetoacetic esters; and
xi. others such as hydroxamic esters as for example benzyl methacrylohydroxamate (BMH) or allyl methacrylohydroxamate, and carbamates such as phenyl N-phenylcarbamate or 2-oxazolidone.

Amongst the above blocking agents, the oximes (group iii.), particularly methyl ethyl ketoxime and the pyrazoles (group vi.), particularly 3,5-dimethylpyrazole are most preferred.

The blocking agents of group x. do not react in a deblocking reaction at elevated temperature, but in a transesterification of the ester groups present therein, when reacted with alcohols, particularly polyols.

One of the advantages of the present invention is, that the fully blocked polyisocyanate can be obtained just prior to method step a. in the same reaction container.

Method Step b. (Obtaining of Mixture B)

In method step b. the prepolymer contained in mixture A as obtained in method step a. is reacted with one or more hydroxy-functional polymers to obtain a polyurethane containing mixture B.

Preferably the hydroxy-functional polymers are selected from the group consisting of polyester polyols, polyether polyols, polycarbonate polyols and poly(meth)acrylate polyols or mixtures thereof. Amongst the before-mentioned hydroxy-functional polymers the polyester polyols are most preferred. Polyols as defined herein contain at least 2 hydroxyl groups.

The polyester polyols are preferably prepared from a mixture of diols and/or polyols with dicarboxylic acids and/or polycarboxylic acids and/or the anhydrides of the aforementioned acids.

Particularly preferred are polyester polyols prepared by using one or more dicarboxylic acids of formula (6) or dicarboxylic acid anhydrides of formula (6′):

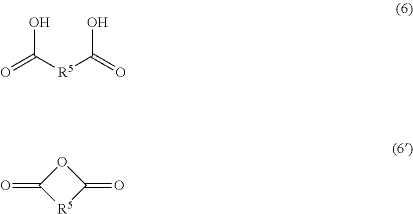

wherein R⁵ is a hydrocarbon residue preferably containing from 10 to 40, more preferred 12 to 36 and most preferred 14 to 34 carbon atoms;

the number of carbon atoms (nₗᵢₙₖₑᵣ) forming the shortest linking group between the carbon atoms forming the two COOH groups in formula (6) or the anhydride group in formula (6′) is from 2 to 20, preferably 2 to 18; and nₗᵢₙₖₑᵣ<total number of carbon atoms in residue R⁵.

Particularly preferred, the number of carbon atoms (nₗᵢₙₖₑᵣ) forming the shortest linking group between the carbon atoms forming the anhydride group in formula (6′) is 2 to 6, more preferred 2 to 4 and most preferred 2.

The most preferred polyester polyols are linear or branched and have a number average molecular weight from 340 to 5000 g/mol, more preferred 400 to 4000 g/mol and most preferred 500 to 3500 g/mol as determined by gel permeation chromatography (GPC) using a polystyrene standard (e.g. Agilent 1200 series; detector: Agilent RI G1362A+UV G1314F; eluent: THF+1 vol. % acetic acid).

Preferably the polyester polyols have an acid number in the range from 1 to 20 mg KOH/g, more preferred from 1 to 15 mg KOH/g and most preferred from 1 to 10 mg KOH/g.

Preferably the polyester polyols have hydroxyl number in the range from 50 to 280 mg KOH/g, more preferred from 65 to 250 mg KOH/g and most preferred from 70 to 230 mg KOH/g, such as 120 to 230 mg KOH/g.

Method Step c. (Neutralization)

In case the polyurethane obtained in method step b. contains acid groups, the acid groups are preferably neutralized. The neutralizing agent is preferably employed in an amount to neutralize 20 to 100 mol.-% and most preferred 50 to 100 mol.-% of the acidic groups. This can be achieved by the determination of the acid number of the dispersion according to DIN EN ISO 2114 (method A) calculating the respective amount of neutralizing agent needed to neutralize the polyurethane to the desired degree and adding this amount of neutralizing agent to the polyurethane. In case a total neutralization is desired, it is preferred to add an excess of neutralizing agents such as 1.1- to 2-fold amount of the theoretically needed amount of neutralizing agent. Preferred neutralizing agents are alkali metal hydroxides such as sodium hydroxide, potassium hydroxide and lithium hydroxide, and amines such as diethylamine, ammonia, ethylamine, triethylamine, propylamine, isopropylamine, dipropylamine, butylamine, isobutylamine, triethanolamine, diethanolamine, aminomethylpropanol, N,N-dimethyl ethanolamine and morpholine.

One-Pack Polyurethane Dispersion According to the Invention

The polyurethane dispersions according to the present invention are one-pack polyurethane dispersions. Due to the presence of hydrophilic moieties (acid groups, polyalkoxylene groups) in the polyurethane introduced via the isocyanate containing prepolymer, the one-pack polyurethane dispersions according to the present invention are most suitable as aqueous dispersions. While those polyurethanes containing non-ionic polyalkoxylene moieties are typically water-dispersible as such, those containing an acid group typically need to be partially or fully neutralized in method step c. to become water-dispersible. However, in case of the acid groups, hydrophilicity can be controlled by the extent of neutralization of the very same polyurethane.

Therefore, the polyurethane dispersions according to the present invention are preferably aqueous polyurethane dispersions and are obtainable according to the inventive method.

The polyurethane dispersions of the present invention preferably contain from 40 wt.-% to 75 wt.-%, more preferred 40 wt.-% to 65 wt.-% and most preferred 50 to 62 wt.-% of water.

The polyurethane dispersion according to the present invention, preferably have a solids content of 25 to 60 wt.-%, more preferred 35 to 60 wt.-% and most preferred 38 to 50 wt-%, based on the total weight of the polyurethane dispersion.

The solids content of the polyurethane dispersion is determined by drying the polyurethane dispersion at a temperature of 130° C. for 60 min according to DIN EN ISO 3251.

At a given solids content, the polyurethane dispersions obtained according to the present invention have a remarkably low viscosity, which makes it possible to use them at a high solids content, without further dilution.

Coating Material According to the Invention

The coating material according to the present invention is preferably an aqueous or water-borne coating material, most preferably an aqueous or water-borne one-pack coating material.

The polyurethane dispersions according to the present invention can be suitably employed in any aqueous or water-borne coating material. Preferably the polyurethane dispersions of the present invention are employed in primer coating materials, filler coating materials and/or base coating materials, preferably as the main or one of the main film-forming materials.

Further Film-Forming Materials

Beside the polyurethane dispersions according to the present invention the coating materials according to the present invention preferably contain one or more further film-forming materials. Examples for such film-forming materials are e.g. described in EP0574417, DE19948004, EP0521928, EP1171535, EP3247755 and EP3083742.

Crosslinkers

The one-pack coating material containing the polyurethane dispersions according to the present invention and optionally containing further active hydrogen-functional film-forming materials, preferably further includes at least one additional crosslinker reactive with hydroxyl groups, besides the fully blocked polyisocyanate introduced with the polyurethane dispersion.

Preferred crosslinkers for one-pack coating materials are aminoplast crosslinkers having active methylol, methylalkoxy or butylalkoxy groups and blocked polyisocyanate crosslinkers, which could be reactive with the hydroxyl groups as well as with non-neutralized carboxylic acid groups.

Aminoplasts, or amino resins, are described in Encyclopedia of Polymer Science and Technology vol. 1, p. 752-789 (1985). An aminoplast is obtained by reaction of an activated nitrogen with a lower molecular weight aldehyde, optionally with further reaction with an alcohol (preferably a mono-alcohol with one to four carbon atoms such as methanol, isopropanol, n-butanol, isobutanol, etc.) to form an ether group. Preferred examples of activated nitrogens are activated amines such as melamine, benzoguanamine, cyclohexylcarboguanamine, and acetoguanamine; ureas, including urea itself, thiourea, ethylene urea, dihydroxyethylene urea, and guanyl urea; glycoluril; amides, such as dicyandiamide; and carbamate-functional compounds having at least one primary carbamate group or at least two secondary carbamate groups. The activated nitrogen is reacted with a lower molecular weight aldehyde. The aldehyde may be selected from formaldehyde, acetaldehyde, crotonaldehyde, benzaldehyde, or other aldehydes used in making aminoplast resins, although formaldehyde and acetaldehyde, especially formaldehyde, are preferred. The activated nitrogen groups are at least partially alkylolated with the aldehyde, and may be fully alkylolated; preferably the activated nitrogen groups are fully alkylolated. The reaction may be catalyzed by an acid, e.g. as taught in U.S. Pat. No. 3,082,180, which is incorporated herein by reference.

The optional alkylol groups formed by the reaction of the activated nitrogen with aldehyde may be partially or fully etherified with one or more monofunctional alcohols. Suitable examples of the monofunctional alcohols include, without limitation, methanol, ethanol, n-propanol, isopropanol, n-butanol, isobutanol, tert-butyl alcohol, benzyl alcohol, and so on. Monofunctional alcohols having one to four carbon atoms and mixtures of these are preferred. The etherification may be carried out, for example, the processes disclosed in U.S. Pat. Nos. 4,105,708 and 4,293,692. The aminoplast may be at least partially etherified, but can be fully etherified. For example, the aminoplast compounds may have a plurality of methylol and/or etherified methylol, butylol, or alkylol groups, which may be present in any combination and along with unsubstituted nitrogen hydrogens. Examples of suitable curing agent compounds include, without limitation, melamine formaldehyde resins, including monomeric or polymeric melamine resins and partially or fully alkylated melamine resins, and urea resins (e.g. methylol ureas such as urea formaldehyde resin, and alkoxy ureas such as butylated urea formaldehyde resin). One example of a fully etherified melamine-formaldehyde resin is hexamethoxymethyl melamine.

The alkylol groups are capable of self-reaction to form oligomeric and polymeric aminoplast crosslinking agents. Useful materials are characterized by a degree of polymerization. For melamine formaldehyde resins, it is preferred to use resins having a number average molecular weight less than about 2000, more preferably less than 1500, and even more preferably less than 1000.

Catalysts

Coating materials including aminoplast crosslinking agents may further include a strong acid catalyst to enhance the cure reaction. Such catalysts are well known in the art and include, for example, para-toluenesulfonic acid, dinonylnaphthalene disulfonic acid, dodecylbenzenesulfonic acid, phenyl acid phosphate, monobutyl maleate, butyl phosphate, and hydroxy phosphate ester. Strong acid catalysts are often blocked, e.g. with an amine.

Further preferred catalysts are for example organotin catalysts and bismuth-based catalysts. Amongst the organotin catalysts dialkyltin dicarboxylates such as dibutyltin dilaurate or dioctyltin dilaurate are preferred. Amongst the bismuth-based catalysts bismuth carboxylates such as bismuth neodecanoate or bismuth ethylhexanoate are preferred.

Solvents, Pigments, Fillers and Additives

The coating materials of the present invention typically further include solvents, pigments, fillers, and/or customary additives.

While the coating materials of the present invention are preferably water-borne or aqueous coating materials, they typically contain one or more organic solvents in minor amounts. Solvents are typically used to either dissolve or disperse film-forming materials beside the polyurethane dispersions of the present invention or other materials and additives. In general, depending on the solubility characteristics of the components, the solvent, beside water, can be any organic solvent.

The solvents are preferably polar organic solvent, but also aromatic solvents can be employed to some extent. Among useful solvents are ketones, esters, acetates, aprotic amides, aprotic sulfoxides, and aprotic amines. Examples of specific useful solvents include ketones, such as acetone, methyl ethyl ketone, methyl amyl ketone, methyl isobutyl ketone, esters such as ethyl acetate, butyl acetate, pentyl acetate, ethyl ethoxypropionate, ethylene glycol butyl ether acetate, propylene glycol monomethyl ether acetate, aliphatic and/or aromatic hydrocarbons such as toluene, xylene, solvent naphtha, and mineral spirits, ethers such as glycol ethers like propylene glycol monomethyl ether, alcohols such as ethanol, propanol, isopropanol, n-butanol, isobutanol, and tert-butanol or alkoxyalkanoles, such as methoxypropanol or di(propyleneglycol) monomethyl ether, nitrogen-containing compounds such as N-methyl pyrrolidone and N-ethyl pyrrolidone, and combinations of these.

The organic solvents in the coating material may be present in an amount of from 0 wt.-% to 30 wt.-%, preferably in an amount of from 0.5 wt.-% to 20 wt.-%, or more preferred in an amount of from 1 wt.-% to 10 wt.-% and most preferred in an amount from 1 to 5 wt.-%, based on the total weight of the coating material.

When the coating materials are formulated as primer coating materials, filler coating materials, base coat coating materials or topcoat coating materials they preferably contain pigments and/or fillers, including special effect pigments.

Examples of special effect pigments that may be utilized in base coat materials include metallic, pearlescent, and color-variable effect flake pigments. Metallic (including pearlescent, and color-variable) topcoat colors are produced using one or more special flake pigments. Metallic colors are generally defined as colors having gonioapparent effects. For example, the American Society of Testing Methods (ASTM) document F284 defines metallic as “pertaining to the appearance of a gonioapparent material containing metal flake.” Metallic base coat colors may be produced using metallic flake pigments like aluminum flake pigments, coated aluminum flake pigments, copper flake pigments, zinc flake pigments, stainless steel flake pigments, and bronze flake pigments and/or using pearlescent flake pigments including treated micas like titanium dioxide-coated mica pigments and iron oxide-coated mica pigments to give the coatings a different appearance (degree of reflectance or color) when viewed at different angles. Metal flakes may be cornflake type, lenticular, or circulation-resistant; micas may be natural, synthetic, or aluminum oxide type. Flake pigments do not agglomerate and are not ground under high shear because high shear would break or bend the flakes or their crystalline morphology, diminishing or destroying the gonioapparent effects. The flake pigments are satisfactorily dispersed in a binder component by stirring under low shear. The flake pigment or pigments may be included in the coating material in an amount of about 0.01 wt. % to about 50 wt. % or about 15 wt. % to about 25 wt. %, in each case based on total binder weight.

Examples of other suitable pigments and fillers that may be utilized in primer coating materials, filler coating materials, base coat coating materials and topcoat coating materials include inorganic pigments such as titanium dioxide, barium sulfate, carbon black, ocher, sienna, umber, hematite, limonite, red iron oxide, transparent red iron oxide, black iron oxide, brown iron oxide, chromium oxide green, strontium chromate, zinc phosphate, silicas such as fumed silica, calcium carbonate, talc, barytes, ferric ammonium ferrocyanide (Prussian blue), and ultramarine, and organic pigments such as metallized and non-metallized azo reds, quinacridone reds and violets, perylene reds, copper phthalocyanine blues and greens, carbazole violet, monoarylide and diarylide yellows, benzimidazolone yellows, tolyl orange, naphthol orange, nanoparticles based on silicon dioxide, aluminum oxide or zirconium oxide, and so on. The pigment or pigments are preferably dispersed in a resin or polymer or with a pigment dispersant, such as binder resins of the kind already described, according to known methods. In general, the pigment and dispersing resin, polymer, or dispersant are brought into contact under a shear high enough to break the pigment agglomerates down to the primary pigment particles and to wet the surface of the pigment particles with the dispersing resin, polymer, or dispersant. The breaking of the agglomerates and wetting of the primary pigment particles are important for pigment stability and color development. Pigments and fillers may be utilized in amounts typically of up to about 60% by weight, based on total weight of the coating material. The amount of pigment used depends on the nature of the pigment and on the depth of the color and/or the intensity of the effect it is intended to produce, and also by the dispersibility of the pigments in the pigmented coating material. The pigment content, based in each case on the total weight of the pigmented coating material, is preferably 0.5% to 50%, more preferably 1% to 30%, very preferably 2% to 20%, and more particularly 2.5% to 10% by weight. Pigments and fillers can be employed in form of mill bases or pastes.

Additionally, customary coating additives may be included, for example, surfactants, stabilizers, wetting agents, dispersing agents, adhesion promoters, UV absorbers, hindered amine light stabilizers such as HALS compounds, benzotriazoles or oxalanilides; free-radical scavengers; slip additives; defoamers; reactive diluents, of the kind which are common knowledge from the prior art; wetting agents such as siloxanes, fluorine compounds, carboxylic monoesters, phosphoric esters, polyacrylic acids and their copolymers, for example polybutyl acrylate, or polyurethanes; adhesion promoters such as tricyclodecanedimethanol; flow control agents; film-forming assistants such as cellulose derivatives; rheology control additives; inorganic phyllosilicates such as aluminum-magnesium silicates, sodium-magnesium and sodium-magnesium-fluorine-lithium phyllosilicates of the montmorillonite type; silicas such as Aerosil®; or synthetic polymers containing ionic and/or associative groups such as polyvinyl alcohol, poly(meth)acrylamide, poly(meth)acrylic acid, polyvinylpyrrolidone, styrene-maleic anhydride copolymers or ethylene-maleic anhydride copolymers and their derivatives, or hydrophobically modified ethoxylated urethanes or polyacrylates; flame retardant; and so on. Typical coating materials include one or a combination of such additives.

Method of Coating a Substrate and an Accordingly Coated Substrate

Accordingly, a further object of the present invention is a method of coating a substrate with the coating compositions according to the invention, the method comprising applying the coating composition according to the present invention onto a substrate to form a coating layer and curing the coating layer at a temperature in the range from about 100° C. to about 200° C. for preferably about 5 to about 30 minutes. Further object of the present invention are coated substrates, which are obtainable by the method according to the invention.

The coating materials of the invention can be coated by any of several techniques well known in the art. These include, for example, spray coating, dip coating, roll coating, curtain coating, knife coating, spreading, pouring, dipping, impregnating, trickling or rolling, and the like. For automotive body panels, spray coating is typically used. Preference is given to employing spray application methods, such as compressed-air spraying, airless spraying, high-speed rotation, electrostatic spray application, alone or in conjunction with hot spray application such as hot-air spraying, for example.

The coating materials and coating systems of the invention are employed in particular in the technologically and esthetically particularly demanding field of automotive OEM finishing. The coating materials can be used in both single-stage and multistage coating methods.

The applied coating materials can be cured after a certain rest time or “flash” period. The rest time serves, for example, for the leveling and devolatilization of the coating films or for the evaporation of volatile constituents such as solvents. The rest time may be assisted or shortened by the application of elevated temperatures or by a reduced humidity, provided this does not entail any damage or alteration to the coating films, such as premature crosslinking, for instance.

The thermal curing of the coating materials has no peculiarities in terms of method but instead takes place in accordance with the typical, known methods such as heating in a forced-air oven or irradiation with IR lamps. The thermal cure may also take place in stages. Another preferred curing method is that of curing with near infrared (NIR) radiation.

Generally, heat curing is affected by exposing the coated article to elevated temperatures provided primarily by radiative heat sources. After application, the applied coating layer is cured, for example with heat at temperatures from above 100° C. to 200° C., or from 110 to 190° C., or from 120 to 180° C., for a time of 5 min up to 30 min, and more preferably 10 min up to 25 min.

The layer thicknesses of the cured layers of the coating material according to the present invention formed on substrates are as follows. Cured primer layers, if applied, formed from the coating material of the present invention typically have thicknesses of from about 12 μm to about 25 μm. Cured filler layers, if applied, formed from the coating material of the present invention typically have thicknesses of from about 10 μm to about 40 μm. Cured base coat layers, if applied, formed from the coating material of the present invention typically have a thickness of from about 10 to about 25 μm. Cured clear coat layers, if applied, formed from the coating material of the present invention typically have a thickness of from about 20 to about 40 μm.

Preferably the substrate materials are chosen from the group consisting of metals, polymers, wood, glass, mineral-based materials and composites of any of the aforementioned materials.

The term metal comprises metallic elements like iron, aluminum, zinc, copper and the like as well as alloys such as steel like bare steel, cold-rolled steel, galvanized steel and the like. Polymers can be thermoplastic, duroplastic or elastomeric polymers, duroplastic and thermoplastic polymers being preferred. Mineral-based materials encompass materials such as e.g. hardened cement and concrete. Composite materials are e.g. fiber-reinforced polymers etc.

Of course, it is possible to use pre-treated substrates, where the pre-treatment regularly depends on the chemical nature of the substrate.

Preferably, the substrates are cleaned before use, e.g. to remove dust, fats, oils or other substances which typically prevent a good adhesion of coatings. The substrate can further be treated with adhesion promoters to increase the adhesion of subsequent coatings.

Metallic substrates may comprise a so-called conversion coat layer and/or electrodeposition coat layer before being coated with the coating composition according to the present invention. This is particularly the case for substrates in the automotive coating field such as automotive OEM and automotive refinish coating.

The electrodeposition composition used to form the electrodeposition coat layer can be any electrodeposition composition used in automotive vehicle coating operations. Non-limiting examples of electrocoat compositions include electrocoating materials sold by BASF. Electrodeposition coating baths usually comprise an aqueous dispersion or emulsion including a principal film-forming epoxy resin having ionic stabilization (e.g. salted amine groups) in water or a mixture of water and organic cosolvent. Emulsified with the principal film-forming resin is a crosslinking agent that can react with functional groups on the principal resin under appropriate conditions, such as with the application of heat, and so cure the coating. Suitable examples of crosslinking agents include, without limitation, blocked polyisocyanates. The electrodeposition coating materials usually include one or more pigments, catalysts, plasticizers, coalescing aids, antifoaming aids, flow control agents, wetting agents, surfactants, UV absorbers, HALS compounds, antioxidants, and other additives.

The electrodeposition coating material is preferably applied to a dry film thickness of 10 to 25 μm. After application, the coated vehicle body is removed from the bath and rinsed with deionized water. The coating may be cured under appropriate conditions, for example by baking at from about 135° C. to about 190° C. for preferably about 15 to about 60 minutes.

For polymeric substrates pretreatment may include, for example, treatment with fluorine, or a plasma, corona or flame treatment. Often the surface is also sanded and/or polished. The cleaning can also be done manually by wiping with solvents with or without previous grinding or by means of common automated procedures, such as carbon dioxide cleaning.

Any of the above substrates can also be pre-coated with one or more fillers and/or one or more base coats prior to the formation of the coating layer. Such fillers and base coats may contain color pigments and/or effect pigments such as metallic effect pigments as e.g. aluminum pigments; or pearlescent pigments as e.g. mica pigments. This is particularly the case for substrates in the automotive coating field such as automotive OEM and automotive refinish coating.

Depending on the substrate material chosen, the coating compositions can be applied in a wide variety of different application areas. Many kinds of substrates can be coated. The coating compositions of the invention are therefore outstandingly suitable for use as decorative and protective coating systems, particularly for bodies of means of transport (especially motor vehicles, such as motorcycles, buses, trucks or automobiles) or parts thereof. The substrates preferably comprise a multilayer coating as used in automotive coating.

The coating compositions of the invention are also suitable for use on constructions, interior and exterior; on furniture, windows and doors; on plastics moldings, especially CDs and windows; on small industrial parts, on coils, containers, and packaging; on white goods; on sheets; on optical, electrical and mechanical components, and on hollow glassware and articles of everyday use.

Accordingly, a further object of the present invention is a substrate coated according to the inventive method of coating. The coating on the substrate can be cured or uncured, preferably being cured.

Multilayer Coatings and Multilayer-Coated Substrates

Yet another object of the present invention is a multilayer coating, which can be cured or uncured, preferably being cured, consisting of at least two coating layers, at least one of which is formed from an inventive polyurethane dispersion or from a coating material according to the present invention. Typically, the multilayer coating comprises more than two coating layers.

A preferred multilayer coating comprises at least one pigment and/or filler containing layer, such as a primer coat layer, filler coat layer or a base coat layer; and at least one clear coat layer. The coating materials of the present invention preferably form the pigment and/or filler containing layer.

Even more preferred is a multilayer coating comprising at least one filler coat layer, coated with at least one base coat layer, which again is coated with at least one clear coat layer.

Particularly, but not limited to automotive coating a multilayer coating preferably comprises an electro coat layer, at least one filler coat layer on top of the electro coat layer, coated with at least one base coat layer, which again is coated with at least one clear coat layer.

The above multilayer coatings can be applied to any of the substrates named above, typically, but not limited to pretreated substrates. Therefore, another object of the present invention is a multilayer-coated substrate, coated with any of the above multilayer coatings, the multilayer coating being cured or uncured, preferably being cured.

In the following the invention is exemplified by means of experimental data.

### EXAMPLES

Viscosity Measurement

The viscosities as shown below were determined with a rotational rheometer (RheolabQC from Anton Paar GmbH, Graz, Austria) using a cylindric cc27 system at a temperature of 23° C. and a shear rate of 150 s⁻¹.

### Preparation of a Methyl Ethyl Ketoxime Capped HDI-Trimer (CL A)

In a suitable reactor equipped with a stirrer and condenser unit was charged 1037.5 g hexamethylene diisocyanate oligomer (e.g. Desmodur N3300) and 499.2 g 2-butanone. At 45° C. 463.3 g methyl ethyl ketoxime was added and the temperature was raised to and maintained at 70-75° C. until NCO-content was ≤0.1% as determined by titration. The solids content of the reaction mixture was adjusted to 75 wt.-%.

η=approx. 625 mPa*s (23° C., Rheolab, 150 s⁻¹)

### Preparation of a Methyl Ethyl Ketoxime Capped IPDI-Trimer (CL B)

In a suitable reactor equipped with a stirrer and condenser unit was charged 1929.7 g isophorone diisocyanate oligomer (e.g. Desmodur Z4470 70% MPA/X) and 200.0 g 2-butanone. At 50° C. 478.3 g methyl ethyl ketoxime was added and the temperature was raised to and maintained at 70-75° C. until NCO-content is ≤0.1% as determined by titration. Solvent-losses are compensated with 2-butanone and the solids content of the reaction mixture was adjusted to 80%.

η=approx. 2000 mPa*s (23° C., Rheolab, 150 s⁻¹)

### Preparation of a 3,5-Dimethylpyrazole Capped HDI-Trimer (CL C)

In a suitable reactor equipped with a stirrer and condenser unit was charged 1519.6 g hexamethylene diisocyanate oligomer (e.g. Desmodur N3300) and 509.9 g 2-butanone. At 40° C. 767.8 g 3,5-dimethylpyrazole was added in three portions and the temperature was carefully raised to and maintained at 75° C. until NCO-content is ≤0.1% as determined by titration. The solids content of the reaction mixture was adjusted to 85%.

η=approx. 2350 mPa*s (23° C., Rheolab, 150 s⁻¹)

Polyester PES A

In a reactor equipped with a stirrer and dean stark apparatus were charged 633 g 1,6-hexanediol, 253 g trimellitic anhydride, 633 g tetrapropenylsuccinic anhydride and 464 g tripropylene glycol. The temperature was raised to 220° C. and was carefully controlled to reduce monomer losses. Reaction monitoring was done by titration. The polyester polyol was obtained with a hydroxyl number of approximately 210 mg KOH/g, an acid number of approximately 8 mg KOH/g and a number average molecular weight of 928 g/mol. The solids content was 100%.

Polyester PES B

According to WO 2015/007427A1, p. 24, example D-P1 and p. 26, example D-P2 a linear polyester polyol was synthesized by using 443 g 1,6-hexanediol, 241 g isophthalic anhydride and 813 g dimeric fatty acid. The polyester polyol was obtained with a hydroxyl number of 73 mg KOH/g, an acid number of <4 mg KOH/g and a number average molecular weight of 1379 g/mol. Dilution to a solids content of approximately 73 wt.-% was achieved by butane-2-one.

Preparation of Polyurethane Dispersions

Preparation of Polyurethane Dispersions According to the Inventive Method (Examples 1 to 6; Tables 1 and 2)

General Procedure

In a suitable reactor equipped with a stirrer and condenser unit was charged CL A, CL B or CL C as Ingredient 11, diisocyanate 12, dimethylolpropionic acid (13) and neopentyl glycol (14) at room temperature. The reaction mixture is diluted with 2-butanone (15). Then, the temperature was raised to 80° C. and the reaction process was monitored by titration of the NCO-content. The hydroxy-terminated polyester 16 (PES A/PES B) was added before the theoretical NCO content was achieved. The reaction temperature was maintained at 80° C. until NCO-content ≤0.1%. The polymeric mixture was mixed with dimethylamino ethanol (17) to achieve a neutralization level of 95-105% according to the determined acid value and emulsified in deionized water (18). The process solvent was removed under reduced pressure and the corresponding self-crosslinking polyurethane dispersion was achieved.

Preparation of Comparative Polyurethane Dispersions (Examples 1′ to 6′; Tables 1 and 2)

General Procedure

In a suitable reactor equipped with a stirrer and condenser unit was charged diisocyanate I1, dimethylolpropionic acid (I2) and neopentyl glycol (I3) at room temperature. The reaction mixture is diluted with 2-butanone (I4). Then, the temperature was raised to 80° C. and the reaction process was monitored by titration of the NCO-content. The hydroxy-terminated polyester I5 (PES A/PES B) was added as the theoretical NCO-content was achieved. The reaction temperature was maintained at 80° C. until NCO-content ≤0.1%. The polyurethane was mixed with CL A, CL B or CL C (I6) and the mixture was stirred for further 30 minutes. Then, dimethylamino ethanol (I7) was added to achieve a neutralization level of 95-105% according to the determined acid value and the mixture was emulsified in deionized water (I8). The process solvent was removed under reduced pressure and the corresponding self-crosslinking polyurethane dispersion was achieved.

TABLE 1
Reactor loading sequence - crosslinker variation

| Ingredients | Exp. 1 | Exp. 1′ | Exp. 2 | Exp. 2′ | Exp. 3 | Exp. 3′ |
|---|---|---|---|---|---|---|
| I1 | CL A | HMDI | CL B | HMDI | CL C | HMDI |
| | 726 g | 370 g | 479 g | 370 g | 633 g | 370 g |
| I2 | HMDI | DMPA | HMDI | DMPA | HMDI | DMPA |
| | 370 g | 79.1 g | 370 g | 79.1 g | 370 g | 79.1 g |
| I3 | DMPA | NPG | DMPA | NPG | DMPA | NPG |
| | 79.1 g | 10.8 g | 79.1 g | 10.8 g | 79.1 g | 10.8 g |
| I4 | NPG | Butan-2-one | NPG | Butan-2-one | NPG | Butan-2-one |
| | 10.8 g | 360 g | 10.8 g | 300 g | 10.8 g | 300 g |
| I5 | Butan-2-one | PES A | Butan-2-one | PES A | Butan-2-one | PES A |
| | 180 g | 1074 g | 300 g | 1074 g | 300 g | 1074 g |
| I6 | PES A | CL A | PES A | CL B | PES A | CL C |
| | 1074 g | 730 g | 1074 g | 479 g | 1074 g | 633 g |
| I7 | DMEA | DMEA | DMEA | DMEA | DMEA | DMEA |
| I8 | H₂O | H₂O | H₂O | H₂O | H₂O | H₂O |
| Viscosity | 1928 mPas | 6392 mPas | 405 mPas | 969 mPas | 2100 mPas | 4060 mPas |
| Solids | 42.6% | 41.1% | 40.7% | 37.5% | 40.6% | 41.3% |
| content | | | | | | |

TABLE 2
Reactor loading sequence - diisocyanate and polyester variation

| Ingredients | Exp. 4 | Exp. 4′ | Exp. 5 | Exp. 5′ | Exp. 6 | Exp. 6′ |
|---|---|---|---|---|---|---|
| I1 | CL A | HDI | CL A | IPDI | CL A | HMDI |
| | 676 g | 237 g | 676 g | 313 g | 511 g | 292 g |
| I2 | HDI | DMPA | IPDI | DMPA | HMDI | DMPA |
| | 237 g | 79:1 g | 313 g | 79.1 g | 292 g | 68 g |
| I3 | DMPA | NPG | DMPA | NPG | DMPA | NPG |
| | 79.1 g | 10.8 g | 79.1 g | 10.8 g | 68 g | 5.2 g |
| I4 | NPG | Butan-2-one | NPG | Butan-2-one | NPG | Butan-2-one |
| | 10.8 g | 300 g | 10.8 g | 300 g | 5.2 g | 300 g |
| I5 | Butan-2-one | PES A | Butan-2-one | PES A | Butan-2-one | PES B |
| | 300 g | 1074 g | 300 g | 1074 g | 300 g | 2190 g |
| I6 | PES A | CL A | PES A | CL A | PES B | CL A |
| | 1074 g | 676 g | 1074 g | 676 g | 2190 g | 511 g |
| I7 | DMEA | DMEA | DMEA | DMEA | DMEA | DMEA |
| I8 | H₂O | H₂O | H₂O | H₂O | H₂O | H₂O |
| Viscosity | 1255 mPas | 2430 mPas | 2869 mPas | 4043 mPas | 3851 mPas | n.m.^{#} |
| Solids | 42.8% | 42.8% | 41.3% | 41.5% | 28.5% | 27.0% |
| content | | | | | | |

CL A: Methyl ethyl ketoxime capped HDI-trimer, 75 wt.-% in butan-2-one.
CL B: Methyl ethyl ketoxime capped IPDI-trimer, 70 wt.-% in MPA/xylene/butan-2-one.
CL C: 3,5-Dimethylpyrazole capped HDI-trimer, 84 wt.-% in butan-2-one.
PES A: OH value approx. 210 mg KOH/g (100 wt.-%).
PES B: OH value approx. 73 mg KOH/g, 73 wt.-% in butane-2-one.
^{#}n.m. = not measurable (viscosity too high)

From the above examples it is evident that the polyurethane dispersions obtained according to the present invention (Examples 1 to 6) show, at approximately the same or an even higher solids content, a much lower viscosity compared to the respective comparative examples (Examples 1′ to 6′) manufactured with the same ingredients, but in another reaction sequence.

In-Situ Preparation of Polyurethane Dispersions According to the Inventive Method (Example 7 in Analogy to Example 1)

In a suitable reactor equipped with a stirrer and condenser unit was charged 372.6 g hexamethylene diisocyanate oligomer (e.g. Desmodur N3300) and 180 g 2-butanone. At 45° C. 166.4 g methyl ethyl ketoxime was added and the temperature was raised to and maintained at 70-75° C. until NCO-content is ≤0.1% as determined by titration. Subsequently, the temperature was set to 60° C. and the reactor was loaded with 79.2 g dimethylolpropionic acid, 10.8 g neopentyl glycol, 180 g 2-butanone and 370.8 g 4,4′-methylene bis(cyclohexyl isocyanate). At 80° C., the reaction process was monitored by titration of the NCO-content and 1074 g of PES A was added. The reaction temperature was maintained at 80° C. until NCO-content ≤0.1%. The polymeric mixture was mixed with 73.8 g dimethylamino ethanol, stirred for further 30 minutes and emulsified in 2100 g deionized water. The process solvent was removed under reduced pressure and the corresponding self-crosslinking polyurethane dispersion was achieved.

nvc=40.8%

TN=95-100%

η=556 mPa*s (Rheolab, 23° C., 150 s⁻¹)

This example clearly shows that the manufacture of the polyurethane dispersions according to the present invention can be carried out in just one reaction container starting with the manufacture of the fully blocked polyisocyanate without the need of separately storing the fully blocked polyisocyanate before its addition to the reaction mixture as is necessary in the comparative examples.

Preparation of Coating Compositions A (Inventive) and A′ (Comparative)

Two primer compositions were produced, an inventive composition A and a comparative composition A′ containing the polyurethane dispersion of inventive Example 3 and comparative Example 3′, respectively. The ingredients and amounts of ingredients (in parts by weight) employed in the compositions are shown in Table 3.

TABLE 3
Primer compositions A and A′

| | Coating | Coating |
|---|---|---|
| Ingredients | Composition A | Composition A′ |
| Example 3 | 35.8 | — |
| Example 3′ | — | 35.8 |
| non-drying alkyd resin | 8.2 | 8.2 |
| (70 wt.-% in methoxypropanol) | | |
| dimethylethanolamine | 0.6 | 0.6 |
| water | 18.0 | 18.0 |
| titanium dioxide | 27.0 | 27.0 |
| pigment paste (53% solids) | 0.1 | 0.1 |
| talc | 3.3 | 3.3 |
| flow and levelling agent | 0.2 | 0.2 |
| (58% solids) | | |
| defoamer | 0.2 | 0.2 |
| paraffine | 2.0 | 2.0 |
| surfactant | 0.2 | 0.2 |
| polyether-modified siloxanes | 0.6 | 0.6 |
| mixture (76 wt.-% solids) | | |
| melamine formaldehyde resin | 3.8 | 3.8 |
| (94% solids) | | |
| Sum | 100 | 100 |

The primer compositions A and A′ were coated pneumatically (Köhne application machine) onto galvanized steel panels (Gardobond 26S) as substrates which were pre-coated with an electrodeposition coating material (Cathoguard 800, obtainable from BASF Coatings GmbH). The layer thickness of the applied primer layers after flash-off for 5 min at 70° C. was approximately 30 μm. The primer layers were cured for 17 min at 155° C. Afterwards the cured primer layers were post-coated with a commercially available base coat (ColorBrite, available from BASF Coatings GmbH) in a dry-layer thickness of 15-20 μm and a clear coat (iGloss, available from BASF Coatings GmbH) in a dry-layer thickness of 35-50 μm. Base coat layers were dried 10 min at 23° C. and 7 min at 70° C. The clear coat layers were applied and cured for 22 min at 140° C.

After curing the multilayer coating, the hardness of the coatings was determined by recording the Martens hardness on a Fischer H100 device (DIN EN ISO 14577-4). The gloss (at 60°) of the coatings were determined on panels by a BYK Micro-Tri-Gloss device (DIN EN ISO 2813) without basecoat and clearcoat application. The results are presented in Table 4.

TABLE 4
Hardness and gloss of the multilayer coatings

| | Multilayer coating with | Multilayer coating with |
|---|---|---|
| Properties | Coating Composition A | Coating Composition A′ |
| hardness [N/mm²] | 122 | 116 |
| gloss (60°) | 85 | 77 |

As shown in table 4, the multilayer coatings (for hardness: electro coat, primer, base coat and clear coat; for gloss: electro coat and primer) obtained by using the inventive coating composition as primer, shows an increased hardness and an increased gloss at 60° compared to the comparative multilayer coatings. Other properties such as stone chip resistance and adhesion after a steam jet test, are the same for both multilayer coatings. It is surprising that although the primer layer is post-coated with a base coat composition and clear coat composition, still significant differences in the performance of the multilayer coatings are observed, particularly regarding hardness.

1. A method for manufacturing a one-pack polyurethane dispersion, wherein the dispersion comprises
(I) a polyurethane containing hydroxyl groups and at least one group selected from the group consisting of acid groups and polyalkoxylene groups; the acid groups of the polyurethane, if present, being neutralized to an extent from 0 to 100 mol-%, based on the total amount of acid groups; and
(II) a fully blocked polyisocyanate;
characterized in that the method comprises the following steps of
a. manufacturing a prepolymer comprising on average from 1.8 to 2.8 isocyanate groups and comprising urethane groups and at least one group selected from the group consisting of acid groups and polyalkoxylene groups, in the presence of a fully blocked polyisocyanate, thus obtaining mixture A;
b. manufacturing a polyurethane containing hydroxyl groups and at least one group selected from the group consisting of acid groups and polyalkoxylene groups by reacting one or more hydroxy-functional polymers with mixture A, thus obtaining mixture B; and
c. neutralizing from 0 to 100 mol-% of the acid groups, if contained in mixture B, based on the total amount of acid groups in mixture B.

2. The method according to claim 1, wherein in step a. the prepolymer is formed by reacting diisocyanates of formula (1)
OCN—R¹—NCO (1)
wherein R¹ is an aliphatic or aromatic hydrocarbon residue; with diols of formula (2)
HO—R²—OH (2)
wherein R² is an aliphatic or aromatic hydrocarbon residue and R² comprises at least one group selected from the group consisting of acid groups and polyalkoxylene groups; and, if applicable, with diols of formula (3)
HO—R³—OH (3)
wherein R³ is an aliphatic or aromatic hydrocarbon residue, differs from R² and does not contain one or more groups selected from the group consisting of acid groups and polyalkoxylene groups.

3. The method according to claim 2, wherein
in the diisocyanates of formula (1) R¹ is a branched or linear, acyclic aliphatic hydrocarbon residue containing 2 to 16 carbon atoms; and/or R¹ is a cyclic aliphatic hydrocarbon residue or contains acyclic and cyclic moieties and contains 3 to 20 carbon atoms;
and/or
in the diols of formula (2) R² comprises at least one acid group; and/or the diols of formula (2) are depicted by one or more of formulae (2a) and (2b)
HO—[(EtO)ₓ(PrO)_{y}(BuO)_{z}]—H (2a)
(HOCH₂)₂CX¹CH₂O—[(EtO)ₓ(PrO)_{y}(BuO)_{z}]—X² (2b)
wherein Et=ethylene, Pr=propylene and Bu=butylene, x, y, and z are integers, x+y+z=2 to 200, x≥2 and x≥(y+z), X¹ and X² are independently of each other linear alkyl groups or cycloalkyl groups having 3 to 12 carbon atoms.

4. The method of claim 2, wherein diols of formula (3) are employed in the reaction with the diisocyanates of formula (1) and the diols of formula (2).

5. The method of claim 2, wherein the molar ratio of diisocyanates of formula (1) employed in the formation of the prepolymer to the sum of diols of formulae (2) and (3) employed in the formation of the prepolymer is in the range from (2±0.3):1.

6. The method of claim 2, wherein mixture A comprises prepolymers of formula (4)
OCN—R¹—NH—C(O)O—R²—O(O)C—NH—R¹—NCO (4)
and if the diol of formula (3) is employed in the formation of the prepolymer, mixture A further contains one or more prepolymers of formula (4a)
OCN—R¹—NH—C(O)O—R³—O(O)C—NH—R¹—NCO (4a)
residues R¹, R² and R³ being defined as in claims 2 to 5.

7. The method of claim 1, wherein the fully blocked polyisocyanate is obtained by reacting a polyisocyanate of formula (5)
R⁴—(NCO)ₘ (5)
wherein R⁴ is an aliphatic or aromatic residue derived from the oligomerization of an aliphatic or aromatic diisocyanate of formula (1) as defined in claims 2 and 3, and m>2, with one or more blocking agents.

8. The method of claim 2, wherein method step a. is carried out until at least 30 mol-% of the theoretically possible consumption of the isocyanate groups of the diisocyanates of formula (1) is reached and before 100 mol-% of the theoretically possible consumption of the isocyanate groups of the diisocyanates of formula (1) is reached; and the theoretically possible consumption of the isocyanate groups of the diisocyanates of formula (1) is a calculated value assuming that all hydroxyl groups present in the diols of formula (2), and if applicable formula (3) are reacted with the isocyanate groups of the diisocyanates of formula (1).

9. The method of claim 1, wherein the one or more hydroxy-functional polymers used in method step b. to obtain a polyurethane containing mixture B, are selected from the group consisting of polyester polyols, polyether polyols, polycarbonate polyols and poly(meth)acrylate polyols or mixtures thereof.

10. The method of claim 1, wherein the one or more hydroxy-functional polymers are polyester polyols, prepared from a mixture of diols and/or polyols with dicarboxylic acids and/or polycarboxylic acids and/or the anhydrides of the aforementioned acids.

11. The method of claim 10, wherein at least one of the dicarboxylic acids and/or their anhydrides is selected from the group consisting of dicarboxylic acids of formula (6) and dicarboxylic acid anhydrides of formula (6′): 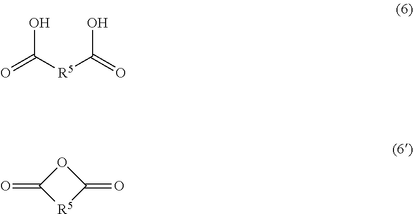
wherein R⁵ is a hydrocarbon residue containing from 10 to 40 carbon atoms;
the number of carbon atoms (nₗᵢₙₖₑᵣ) forming the shortest linking group between the carbon atoms forming the two COOH groups in formula (6) or the anhydride group in formula (6′) is from 2 to 20; and
nₗᵢₙₖₑᵣ<total number of carbon atoms in residue R⁵.

12. A one-pack polyurethane dispersion, obtainable according to the method of claim 1.

13. A one-pack coating material, comprising
the one-pack polyurethane dispersion of claim 12.

14. A method of coating a substrate with the coating material according to claim 13, the method comprising applying the coating material onto a substrate to form a coating layer and curing the coating layer at a temperature in the range from about 100° C. to about 200° C.

15. A coated substrate, obtained by the method of claim 14.

16. A multilayer coating, wherein the multilayer coating consists of at least two coating layers, at least one of which is formed from the one-pack polyurethane dispersion according to claim 12.

17. A multilayer coated substrate, wherein the multilayer consists of at least two coating layers, at least one of which is formed from the one-pack polyurethane dispersion according to claim 12.

18. A multilayer coating, wherein the multilayer coating consists of at least two coating layers, at least one of which is formed from the one-pack coating material according to claim 13.

19. A multilayer coated substrate, wherein the multilayer consists of at least two coating layers, at least one of which is formed from the one-pack coating material according to claim 13.

20. The method according to claim 2, wherein in the diols of formula (2) R² comprises at least one acid group and wherein the at least one acid group is selected from the group consisting of COOH, SO₃H, OP(O)(OH)₂, P(O)(OH)₂ and its corresponding salts.
